(19) United States
(12) Patent Application Publication
(10) Pub. No.: US 2011/0204547 A1
(43) Pub. Date: Aug. 25, 2011

(54) Rotary high speed low compression thermoplastic molding method and apparatus

(76) Inventor: Matt James Lofgren, Alameda, CA (US)

(21) Appl. No.: 12/925,589

(22) Filed: Oct. 25, 2010

Related U.S. Application Data
(60) Provisional application No. 61/254,600, filed on Oct. 23, 2009.

(51) Int. Cl. B28B 5/10

(52) U.S. Cl. 264/297.1; 425/161

(57) ABSTRACT

A molding apparatus includes a plurality of deep-draw compression molds. Each of the molds includes a mold cavity and an associated mold core. A rotating support structure operatively supports the mold cavities and the mold cores relative to each other. The molds open and close as they travel around a closed path defined by the support structure. A mold material discharge mechanism deposits a predetermined amount of mold material in each of the molds. A heat source superheats the molds, and a mold closing mechanism closes the superheated molds, compressing the mold material between the mold cavities and the mold cores to form a deep-draw component A coolant source rapidly and actively cools the molds, and a mold opening mechanism opens the cooled molds. An ejector is disposed to eject the deep draw components from the molds. A method of molding deep-draw components is also disclosed. The system and method of the present invention facilitate compression molding of deep-draw components.

### RELATED APPLICATIONS

This application claims the benefit of priority to copending U.S. Provisional Patent App. No. 61/254,600 filed Oct. 23, 2009 by the same inventor, which is incorporated herein by reference in its entirety.

### BACKGROUND OF THE INVENTION

1. Field of the Invention

This invention relates generally to molding methods and apparatus, and more particularly to a method and apparatus for molding deep draw components.

2. Description of the Background Art

Several different types of molding processes are known. These methods include injection molding and compression molding. Each of these processes has its own advantages and disadvantages and has, therefore, been used predominantly in particular fields and for particular parts based on the respective advantages and disadvantages of each process. Compression molding is a method of molding where the molding material, generally preheated, is first placed in an open, heated mold cavity. The mold is closed, and pressure is applied to force the material into contact with all mold areas, while heat and pressure are maintained until the molding material has cured.

Compression molding is one of the lowest cost molding methods as compared, for example, to injection molding. However, compression molding often provides poor product consistency and difficulty in controlling flashing. Therefore, compression molding is generally considered to not be suitable for some types of components, for example deep-draw components.

Injection molding is a process for producing components from thermoplastic materials. Material is fed into a heated barrel, mixed, and forced into a mold cavity where it cools and hardens to the shape of the mold cavity. Injection molding is widely used for manufacturing a variety of components, including deep-draw components.

Conventional injection molding has hit a capacity threshold. Higher process speeds are nearing their theoretical limit due to cavitation and cycle times. Faster machines and higher cavitation tooling have negligible room to grow in order to meet future demands and further reduction of price per piece. In order to achieve higher outputs, faster molding machines, higher injection velocities, and increased tooling cavitation have been used. For example, 128 cavity stack molds have been used. These improvements have almost reached their physical limits, so only very small improvements in yield can be achieved with greater costs and risks. Therefore, such improvements are generally considered to be cost ineffective. Furthermore, high cavitation tooling is geometrically expensive to produce, requiring tighter tolerances for the tool stacks as the cavitation increases. Higher cavitation tooling also requires a significantly higher level of maintenance, and loss of cavitation changes the processing parameters. Higher injection velocities create significant shear heat which can and will create burning of the material upon injection. In addition, high speed injection molding machines require significantly greater power to operate and highly skilled technicians to operate and maintain the molding machines and associated auxiliary equipment.

What is needed, therefore, is a molding system/process that can efficiently produce deep-draw components. What is also needed is a molding system/process that significantly increases the output rate of deep-draw components compared to conventional processes. What is also needed is a molding system/process that requires lower maintenance and less expensive molds, and that produces higher quality, deep-draw components.

### SUMMARY

The present invention overcomes the problems associated with the prior art by providing a high speed, low compression thermoplastic molding system and method. The invention facilitates compression molding of deep-draw components.

An example molding apparatus includes a plurality of deep-draw compression molds. Each of the molds includes a mold cavity and an associated mold core. A rotating support structure operatively supports the mold cavities and the mold cores relative to each other, and the molds open and close as they travel around a closed path defined by the support structure. A mold material discharge mechanism sequentially deposits a predetermined amount of mold material in each of the molds as the molds pass a first predetermined position along the closed path. A heat source is coupled to heat the molds as the molds travel between the first predetermined position and a second predetermined position along the closed path. A mold closing mechanism is disposed to close the heated molds, compressing the mold material between the mold cavities and the mold cores to form a deep draw component, as the molds travel between the second predetermined position and a third predetermined position along the closed path. A coolant source is coupled to cool the molds as the molds travel between the third predetermined position and a fourth predetermined position along the closed path. A mold opening mechanism is disposed to open the cooled molds as the molds travel between the fourth predetermined position and a fifth predetermined position along the closed path. An ejector is disposed to eject the deep draw components from the molds as the molds pass a sixth predetermined position along the closed path.

The molding apparatus can produce a wide range of deep-draw components. In one embodiment, the deep-draw compression molds have a depth to diameter ratio of greater than one. The deep-draw compression molds can have a depth to diameter ratio of greater than ten.

The heat source super-heats the compression molds. In one embodiment, the heat source conducts super-heated water. In an alternate embodiment, the heat source conducts steam. The molds are heated to temperatures exceeding 212 degrees Fahrenheit.

In an example embodiment, the deep-draw compression molds are designed to mold syringe barrels. The deep-draw compression molds for syringe barrels and other deep-draw components are symmetrical about an axis passing through said mold.

An example deep-draw molding method is also disclosed. The example method includes providing a plurality of deep-draw molds, arranging the molds on a support structure, causing the molds to repeatedly traverse a closed path, depositing a predetermined amount of mold material in each of the molds as the molds pass a first predetermined position along the closed path, heating the molds as the molds travel between the first predetermined position and a second predetermined position along the closed path, compressing the mold material in the molds to form a deep draw component as the molds travel between the second predetermined position and a third predetermined position along the closed path, cooling the molds as the molds travel between the third predetermined position and a fourth predetermined position along the closed path, opening the cooled molds as the molds travel between the fourth predetermined position and a fifth predetermined position along the closed path, and ejecting the deep draw components from the molds as the molds travel between the fifth predetermined position and the first predetermined position along the closed path. The step of compressing the mold material in the molds to form deep draw components includes forming a deep draw component having a depth to diameter ratio of greater than one. In some methods, the step of compressing the mold material in the molds to form deep draw components includes forming deep draw components having a depth to diameter ratio of greater than ten.

In one example method, the step of heating the molds includes heating the molds with super-heated water. Alternatively, the step of heating the molds includes heating the molds with steam. The step of heating the molds includes heating the molds to a temperature exceeding 212 degrees Fahrenheit.

In the example method, the step of compressing the mold material in the molds to form a deep draw component includes forming syringe barrels. In addition to syringe barrels, the step of compressing the mold material in the molds to form a deep draw component can include forming other components that are symmetrical about an axis passing through the components.

Means for super-heating the molds as the molds travel between positions along the closed path are disclosed. Means for cooling the molds as the molds travel between positions along the closed path are also disclosed;

### BRIEF DESCRIPTION OF THE DRAWINGS

The present invention is described with reference to the following drawings, wherein like reference numbers denote substantially similar elements:

FIG. 1 is a representational diagram of a rotary compression molding apparatus;

FIG. 2 shows a compression mold at various stages of a compression molding process; and

FIG. 3 is a flow chart summarizing one method of compression molding a deep draw component.

### DETAILED DESCRIPTION

The present invention overcomes the problems associated with the prior art, by providing a high-speed rotary compression molding method and apparatus. The method and apparatus facilitate compression molding of deep-draw components such as syringe barrels by super- heating the compression molds using, for example, steam or super-heated water. In the following description, numerous specific details are set forth (e.g., number of molds, shape of path of mold travel, etc.) in order to provide a thorough understanding of the invention. Those skilled in the art will recognize, however, that the invention may be practiced apart from these specific details. In other instances, details of well known compression molding practices (e.g., plumbing and wiring details of machine, specific molding materials, etc.) and components (e.g., plumbing and wiring details of machines, etc.) have been omitted, so as not to unnecessarily obscure the present invention.

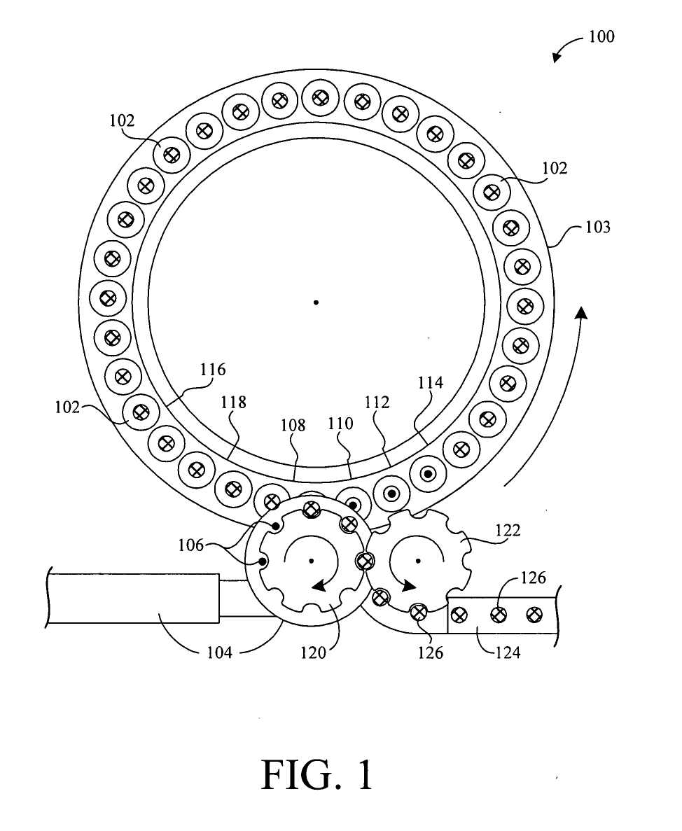

FIG. 1 is a top view of a representational diagram of a rotary high-speed, low compression thermoplastic molding machine. Rotary compression molding machines are generally known in the art and commercially available. However, except as modified by the present invention, known compression molding machines are considered to be incapable of successfully molding deep-draw, thin walled components.

Molding machine 100 includes a plurality (32 in this particular example) of deep-draw compression molds 102, which are supported by a rotating support structure 103. In this embodiment, support structure 103 is circular, so that the molds repeatedly traverse a circular path during the operation of molding machine 100. However, neither the shape of the path, nor the number of molds, is essential to the practice of the invention.

Indeed, the path and the number of molds can be modified to provide more heating and/or cooling time, as might be required for a particular molding process. Extending the path by adding additional molds will increase the time allowed for each molded component to be heated or cooled, but will not adversely affect the overall production rate, because the molds are continuously (one at a time) filled and emptied.

Molding machine 100 further includes a mold material (e.g., thermoplastic) discharge mechanism 104 that sequentially deposits a predetermined amount of mold material 106 into each compression mold 102, as each mold 102 passes between a first position 108 and a second position 110 along the mold's path of travel.

As a particular mold 102 travels between second position 110 and a third position 112, mold 102 is super-heated and closed, and as mold 102 passes between third position 112 and a fourth position 114 the mold compresses the molding material to form a deep-draw component. Between fourth position 114 and a fifth position 116, the mold 102 is actively and rapidly cooled. Then, between fifth position 116 and a sixth position 118, mold 102 is opened.

Molding machine 100 further includes an ejector 120 that removes the molded deep-draw components 126 from molds 102, as molds 102 pass between sixth position 118 and first position 108, where mold 102 begins the next cycle of operation. A transfer mechanism 122 receives deep-draw components 126 from ejector 120 and transfers the components 126 to a conveyor system 124, which transports the finished deep-draw components 126 away from molding machine 100.

Superheating molds 102 significantly reduces the viscosity of the molding material 106 and facilitates the compression molding of deep-draw components, even deep-draw components having thin walls. Deep-draw components have a depth-to-diameter ratio of greater than one, and components having a depth-to-diameter ratio of greater than ten can be molded using the process. Although the present inventive method is not limited to deep-draw components having a circular cross section, particularly good results are achieved when the deep draw component is symmetrical about a longitudinal axis passing through the component. Nevertheless, deep-draw components having elliptical, polygonal, and even irregular cross-sections can be successfully molded using the present invention.

In general, superheating is considered to be heating to temperatures exceeding the normal boiling point of water (212 degrees Fahrenheit). Superheating of molds 102 can be accomplished using steam, superheated water, or any other suitable thermal regulating fluid. The thermal regulating fluid (e.g., steam) is conducted through fluid passages (not shown) formed in the molds 102. Known molds already include fluid passages for heating and cooling fluids of more moderate temperatures. Therefore, these existing fluid passages can be used to superheat the molds, with little or no modification.

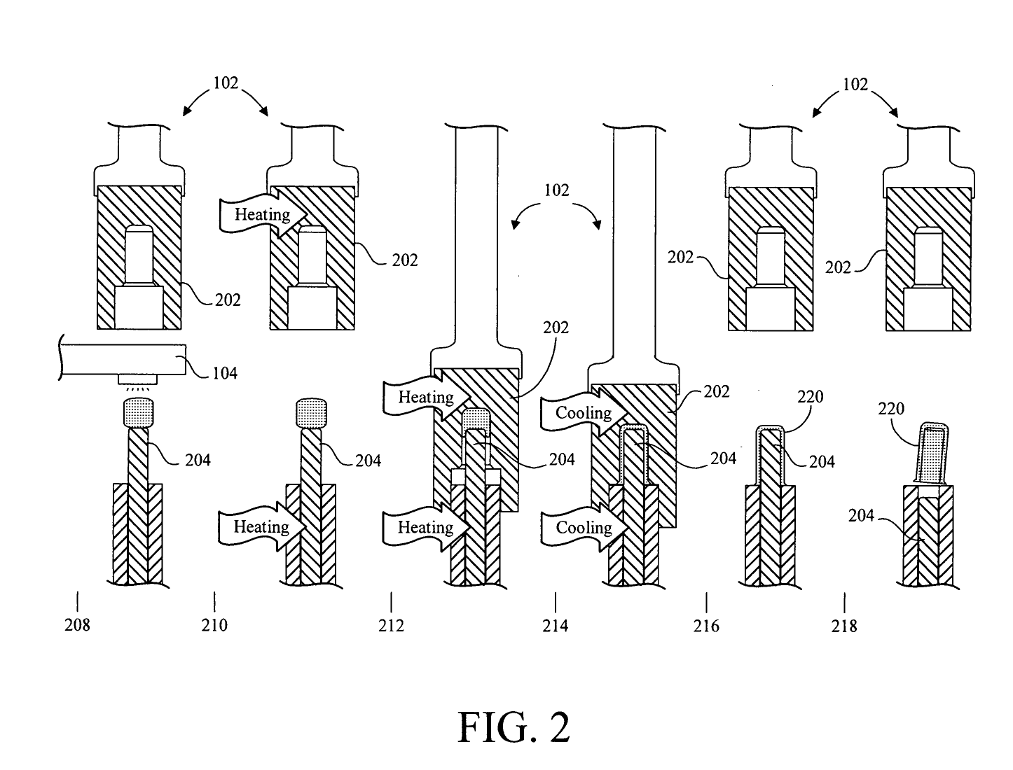

FIG. 2 is a time sequential diagram of a deep-draw compression mold 102, over one cycle of the compression molding process of the present invention. Each mold 102 includes a mold cavity 202 and a mold core 204. Between a first time 208 and a second time 210, mold material discharge mechanism 104 places a slug of mold material 106 on mold core 204. Then, between second time 210 and a third time 212, mold cavity 202 and mold core 204 are superheated. Next, between third time 212 and a fourth time 214, mold 102 is closed, heating of cavity 202 and core 204 continues, and compression molding of material 106 to form a deep-draw component occurs. Then, between fourth time 214 and a fifth time 216, the cavity 202 and the core 204 of mold 102 are actively and rapidly cooled. Next, between fifth time 216 and a sixth time 218, mold 102 is opened. Finally, after sixth time 218, core 204 retracts, and the formed deep-draw component 220 is removed from mold 102.

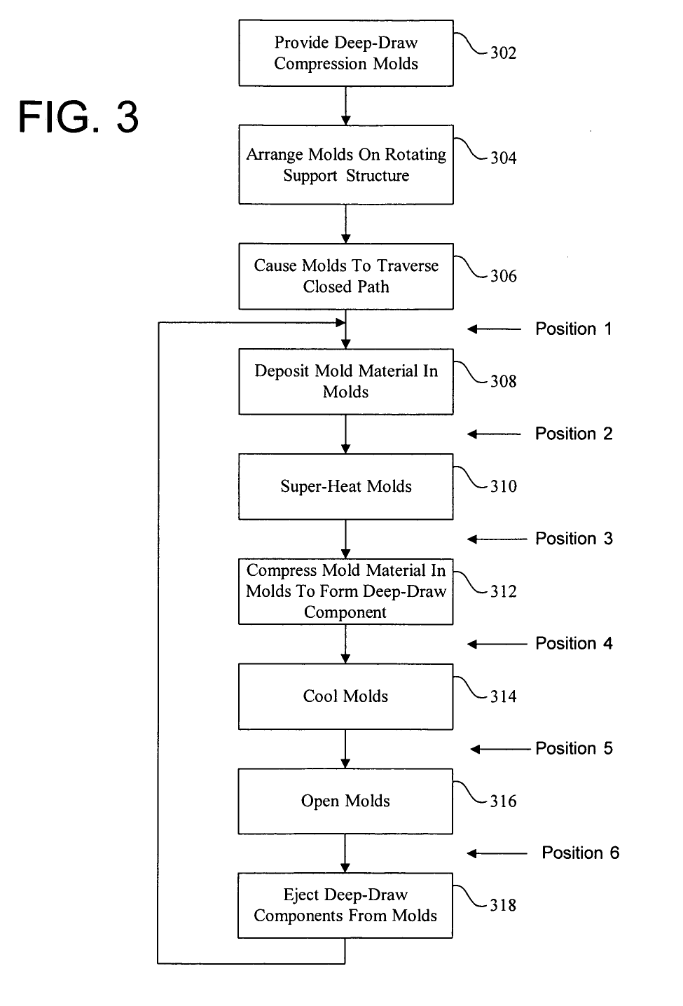

FIG. 3 is a flow chart summarizing one example method of molding a deep-draw component according to the present invention. In a first step 302, a plurality of deep-draw molds are provided. Then, in a second step 304, the molds are arranged on a support structure. Next, in a third step 306, the molds are caused to traverse a closed path. Then, in a fourth step 308, a predetermined amount of mold material is sequentially deposited in each mold. Next, in a fifth step 310, the molds are superheated. Then, in a sixth step 312, the mold material is compressed in the superheated molds to form deep-draw components. Next, in a seventh step 314, the molds are rapidly and actively cooled. Then, in an eighth step 316, the molds are opened, and in a ninth step 318, the deep-draw components are ejected from the molds. It should be understood, that the present method is sequentially performed on a plurality of molds, so that the steps of the process are performed with each mold at slightly different times.

The description of particular embodiments of the present invention is now complete. Many of the described features may be substituted, altered or omitted without departing from the scope of the invention. For example, alternate heaters (e.g., resistive electrical heaters), may be substituted for the thermal regulating fluid used to superheat molds 102. As another example, a greater number of molds and a longer process path can be employed to allow greater cooling time. These and other deviations from the particular embodiments shown will be apparent to those skilled in the art, particularly in view of the foregoing disclosure.

We claim:

1. A molding apparatus comprising:
a plurality of deep-draw compression molds, each of said molds including a mold cavity and an associated mold core;
a rotating support structure operatively supporting said mold cavities and said mold cores relative to each other, said molds opening and closing as they travel around a closed path defined by said support structure;
a mold material discharge mechanism operative to sequentially deposit a predetermined amount of mold material in each of said molds as said molds pass a first predetermined position along said closed path;
a heat source coupled to heat said molds as said molds travel between said first predetermined position and a second predetermined position along said closed path;
a mold closing mechanism disposed to close said heated molds, compressing said mold material between said mold cavities and said mold cores to form a deep draw component, as said molds travel between said second predetermined position and a third predetermined position along said closed path;
a coolant source coupled to cool said molds as said molds travel between said third predetermined position and a fourth predetermined position along said closed path;
a mold opening mechanism disposed to open said cooled molds as said molds travel between said fourth predetermined position and a fifth predetermined position along said closed path; and
an ejector disposed to eject said deep draw components from said molds as said molds pass a sixth predetermined position along said closed path.

2. The molding apparatus of claim 1, wherein said deep-draw compression molds have a. depth to diameter ratio of greater than one.

3. The molding apparatus of claim 2, wherein said deep-draw compression molds have a depth to diameter ratio of greater than ten.

4. The molding apparatus of claim 1, wherein said heat source conducts super-heated water.

5. The molding apparatus of claim 1, wherein said heat source conducts steam.

6. The molding apparatus of claim 1, wherein said molds are heated to a temperature exceeding 212 degrees Fahrenheit.

7. The molding apparatus of claim 1, wherein said deep-draw compression molds are designed to mold syringe barrels.

8. The molding apparatus of claim 1, wherein said deep-draw compression molds are symmetrical about an axis passing through said mold.

9. A molding method comprising:
providing a plurality of deep-draw molds;
arranging said molds on a support structure;
causing said molds to repeatedly traverse a closed path;
depositing a predetermined amount of mold material in each of said molds as said molds pass a first predetermined position along said closed path;
heating said molds as said molds travel between said first predetermined position and a second predetermined position along said closed path;
compressing said mold material in said molds to form a deep draw component, as said molds travel between said second predetermined position and a third predetermined position along said closed path;
cooling said molds as said molds travel between said third predetermined position and a fourth predetermined position along said closed path;
opening said cooled molds as said molds travel between said fourth predetermined position and a fifth predetermined position along said closed path; and
ejecting said deep draw components from said molds as said molds travel between said fifth predetermined position and said first predetermined position along said closed path.

10. The method of claim 9, wherein said step of compressing said mold material in said molds to form deep draw components includes forming deep draw components having a depth to diameter ratio of greater than one.

11. The method of claim 9, wherein said step of compressing said mold material in said molds to form deep draw components includes forming deep draw components having a depth to diameter ratio of greater than ten.

12. The method of claim 9, wherein said step of heating said molds includes heating said molds with super-heated water.

13. The method of claim 9, wherein said step of heating said molds includes heating said molds with steam.

14. The method of claim 9, wherein said step of heating said molds includes heating said molds to a temperature exceeding 212 degrees fahrenheit.

15. The method of claim 9, wherein said step of compressing said mold material in said molds to form a deep draw component includes forming a syringe barrel.

16. The method of claim 9, wherein said step of compressing said mold material in said molds to form a deep draw component includes forming a component that is symmetrical about an axis passing through said component.

17. A molding apparatus comprising:
a plurality of deep-draw compression molds;
a support structure operatively supporting said deep-draw compression molds, said molds opening and closing as they travel around a closed path defined by said support structure;
a mold material discharge mechanism operative to sequentially deposit a predetermined amount of mold material in each of said molds as said molds pass a first predetermined position along said closed path;
means for super-heating said molds as said molds travel between said first predetermined position and a second predetermined position along said closed path;
a mold closing mechanism disposed to close said heated molds, compressing said mold material between said mold cavities and said mold cores to form a deep draw component, as said molds travel between said second predetermined position and a third predetermined position along said closed path;
means for cooling said molds as said molds travel between said third predetermined position and a fourth predetermined position along said closed path;
a mold opening Mechanism disposed to open said cooled molds as said molds travel between said fourth predetermined position and a fifth predetermined position along said closed path; and
an ejector disposed to eject said deep draw components from said molds as said molds pass a sixth predetermined position along said closed path.

18. The molding apparatus of claim 17, wherein said deep-draw compression molds have a depth to diameter ratio of greater than one.

19. The molding apparatus of claim 18, wherein said deep-draw compression molds have a depth to diameter ratio of greater than ten.
